(19) United States
(12) Patent Application Publication
(10) Pub. No.: US 2022/0414316 A1
(43) Pub. Date: Dec. 29, 2022

(54) AUTOMATED LANGUAGE ASSESSMENT FOR WEB APPLICATIONS USING NATURAL LANGUAGE PROCESSING

(71) Applicant: International Business Machines Corporation, Armonk, NY (US)

(72) Inventors: Lin Ju, Markham (CA); Amean Asad, Toronto (CA)

(21) Appl. No.: 17/304,631

(22) Filed: Jun. 23, 2021

(51) Int. Cl. G06F 40/143; G06F 40/205; G06F 40/263; G06K 9/62; G06F 16/958; G06N 20/20

(52) U.S. Cl. CPC G06F 40/143; G06F 40/205; G06F 40/263; G06K 9/6278; G06F 16/958; G06N 20/20

(57) ABSTRACT

A computer assesses language attributes of web application display text elements. The computer receives access to a selected web application. The computer parses hypertext markup language content of the web application and generating a parse tree representing the content. The computer identifies, using the parse tree, display text elements within the content and determining associated element selector queries that identify respective display text elements within the parse tree. The computer processes a set of display text elements, using a plurality of Natural Language Processing classifier models, each of the classifier models generates a relevant language prediction for the processed display text element. The computer collects, for each text element, groups of classifiers associated with substantially-similar predictions and indexed by relevant text element selector. The computer determines a target language match condition for each group. The computer initiates a corresponding at least one corrective action associated with the match condition.

### BACKGROUND

The present invention relates generally to the field of artificial intelligence, and more specifically, to assessing language attributes of display text elements in computer web applications via Natural Language Processing (“NLP”).

Computer applications may be relevant for a variety of international markets and useful for a wide array of audiences. To accommodate these markets and audiences, computer applications are often adapted through a process known as internationalization and localization (commonly abbreviated as “i18n and L10n”), in which various attributes of the application are adjusted to accommodate target audiences. One aspect of this process includes selecting an appropriate language (e.g., a target language) for display text elements shown to application users in a target market. In some cases, accommodating the target language requires translation of display text elements. As computer web applications increase in complexity, it can be difficult to confirm all display text elements are presented in the target language.

### SUMMARY

According to one embodiment, a computer-implemented method for assessing language attributes of web application display text elements, includes receiving, by a computer, access to a selected web application. The computer parses hypertext markup language content of the web application and generating a parse tree representing the content. The computer identifies using the parse tree, display text elements within the content and determining associated element selector queries that identify respective display text elements within the parse tree. The computer processes a set of display text elements, using a plurality of Natural Language Processing (“NLP”) classifier models, wherein each of the classifier models generates a relevant language prediction for each processed display text element. The computer collects for each of the processed display text elements, groups of classifiers associated with substantially-similar predictions and indexed by relevant text element selector. The computer determines an associated target language match condition for each identified group. The computer initiates, in response to determining a preselected target language match condition exists, a corresponding at least one corrective action associated therewith. According to aspects of the invention, the computer identifies primary group of substantially-similar predictions associated with a quantity of classifier models exceeding a primary group threshold of the classifier models. The preselected match condition is that the associated predictions of the primary group are substantially-different from a target language prediction associated with the web application and available to the computer; and wherein the at least one responsive action includes generating a text element language defect report identifying the element selector associated with the at least one processed display text element. According to aspects of the invention, the computer trains any of the plurality of classifier models not included in the primary group, using training data pair including the target language and associated processed display text element. According to aspects of the invention, the computer identifies a primary group of substantially-similar predictions associated with a quantity of classifier models exceeding primary group threshold of the classifier models; wherein the preselected match condition is that the associated predictions of the primary group are substantially-similar to a target language associated with the web application and available to the computer; and wherein the at least one responsive action includes training any of the plurality of classifier models not included in the primary group, using training data pair including the target language and associated processed display text element. According to aspects of the invention, the computer determines that each group of substantially-similar predictions is associated with a quantity of classifier models lower than a primary group threshold of the classifier models; and wherein the at least one responsive action includes generating a text element language defect report identifying the element selector associated with the at least one processed display text element. According to aspects of the invention, the plurality is at least one of classifiers is selected from the group consisting of Naïve Bayes classifiers, Recurrent Neural Network (RNN) classifiers, and support vector machine classifiers. It is noted that other classifiers may be selected in accordance with the judgment of one skilled in this field. According to aspects of the invention, the set display text elements is generated by iterating through the element selectors associated with each respective display text elements within the parse tree.

According to another embodiment, a system for assessing language attributes of web application display text elements includes a computer system comprising a computer readable storage medium having program instructions embodied therewith, the program instructions executable by a computer to cause the computer to: receive access to a selected web application; parse hypertext markup language content of the web application and generating a parse tree representing the content; identify using the parse tree, display text elements within the content and determining associated element selector queries that identify respective display text elements within the parse tree; process a set of display text elements, using a plurality of Natural Language Processing (“NLP”) classifier models, wherein each of the classifier models generates a relevant language prediction for each processed display text element; collect for each of the processed display text elements, groups of classifiers associated with substantially-similar predictions and indexed by relevant text element selector; determine an associated target language match condition for each identified group; and initiate in response to determining a preselected target language match condition exists, a corresponding at least one corrective action associated therewith.

According to another embodiment [CPP] A computer program product for assessing language attributes of web application display text elements, the computer program product comprising a computer readable storage medium having program instructions embodied therewith, the program instructions executable by a computer to cause the computer to:

receive, using a computer, access to a selected web application; parse, using the computer, hypertext markup language content of the web application and generating a parse tree representing the content; identify, using the computer, using the parse tree, display text elements within the content and determining associated element selector queries that identify respective display text elements within the parse tree; process, using the computer, a set of display text elements, using a plurality of Natural Language Processing (“NLP”) classifier models, wherein each of the classifier models generates a relevant language prediction for each processed display text element; collect, using the computer, for each of the processed display text elements, groups of classifiers associated with substantially-similar predictions and indexed by relevant text element selector; determine, using the computer, an associated target language match condition for each identified group; and initiate, using the computer, in response to determining a preselected target language match condition exists, a corresponding at least one corrective action associated therewith.

Aspects of the present invention streamline translation validation and reporting for computer web applications.

Aspects of the present invention identify untranslated strings, highlight errors, and compile an error report for each language being validated.

Aspects of the present invention validate the translation of multiple languages for the same software simultaneously.

In an embodiment, the invention includes into three main parts: a web content parser, a display text element selected language defect classifier, and a report compiler.

According to aspects of the invention, the web content parser extracts content from web applications and parses it to strings.

According to aspects of the invention, the defect classifier applies machine learning algorithms to parsed strings to identify untranslated text on web applications.

According to aspects of the invention, the report compiler highlights defects and compiles a visual report including all the identified defects.

Aspects of the invention support translation validation for several selected languages.

Aspects of the invention provide support for cross browser testing to validate translation for multiple web browsers.

Aspects of the invention, provide web application content access using a web application testing utility with a testing routine created for various locales (e.g., regions having an associated target language), loading the browser with the target language associated with the locale, and navigating through the web application as needed.

Aspects of the invention generate web application utility login metadata as needed if required.

Aspects of the invention will recursively search through a list of URLs, capturing page content associated with each page processed.

Aspects of the invention will parse web application content using an HTML parser (e.g., a parser from the “Beautiful Soup” software library).

According to aspects of the invention a reference object is created for each display text element that includes the element text, the parent HTML element, and the element selector for the element. As used herein, the term “element selector” means a query (or other item written in the XML Path Language for selecting nodes) used to navigate through (or otherwise identify or interact with) each element in a web application (e.g., elements written in Hypertext Markup Language “HTML” or XML).

Aspects of the invention, a language defect identification module (e.g., a Display Text Element Language Processor “DTELP”) uses natural language processing (NLP) models to processes display text elements and classifies the associated language for the elements.

Aspects of the invention use an NLP ensemble learning model to increase prediction accuracy. In an embodiment, the DTELP uses multiple (e.g., 4) NLP models to classify content of display text elements. According to aspects of the invention, if a quantity of classifier models greater than a primary group threshold (e.g., a majority, a designated numerical value such as two, or some other value selected by one skilled in this field) agree on a language translation defect (e.g., the language for a given display text element is not predicted by the threshold to be the web application target language, the display text element is identified as having a language translation defect. It is noted that the indication of a defect can correspond to a display text element for which no primary group (e.g., a group having a quantity larger than a preselected primary group threshold) is identified or for which a primary group of classifier models predicting that the language associated with the text element is not the target language associated with the web application.

According to aspects of the invention, if a display text element is identified as having a language translation defect, the element selector of the element is used to highlight the element (e.g., to place a red border around the element displayed in a display or other user interface). In an embodiment, after all defective elements (e.g., display text elements having a language translation defect) are processed and identified for a web page (or similar web application), a screenshot is taken that shows all the defect on that page. In an embodiment, a folder directory is created for each locale (e.g., region having an associated target language), and the screenshots for each page are stored in that folder marked by the test date.

Aspects of the invention accommodate translation validation of all display text elements (e.g., as indexed and identified by associated element selectors) on a webpage using supported browsers, as assessed by a web application testing utility with a testing routine for various locales.

Aspects of the invention streamline web application language conversion time requirements by providing useful information for developers and translators.

Aspects of the invention produce modular components that may be operated separately in an environment where the components communicatively connected.

Aspects of the invention will, in response to receiving access to web application extracting data for defect classification and error compilation from the web application by a content parsing function using first predetermined criteria to create extracted data forming a parse tree representing a relationship among hypertext markup language content elements within the web application. Aspects of the present invention filter the parse tree to only keep elements that contain text strings visible to a user, with each parse tree element including a text string and an element X-Path containing a query to uniquely identify a respective parse tree element. Aspects of the invention, in response to receiving, by a defect classifier function the elements that contain text strings as input to predict a language of the text strings, process the elements using a configurable number of classifiers running in parallel using a predetermined algorithm used for classification for each classifier. Aspects of the invention will, in response to determining a number of classifiers predict that a text item contains a translation defect exceeds a predetermined threshold, flag a parent element containing this respective text item as containing a translation defect. Aspects of the invention will, in response to retrieving an element selector of the parent element from the parse tree, add the element selector of the parent element to a list specific to a language being validated containing element selectors of all elements flagged as containing translation defects. Aspects of the invention will, in response to collecting all errors in a given test run by an error compiling function, create an error reporting directory by the error compiling function. According to aspects of the invention, an error compiling function can include iterating through each element selector included in the list to uniquely identify a corresponding element in a web browser associated with the web application, visually marking each element included in a webpage as a defect, for each webpage, taking a screenshot including marked defects as identified by the defect classifier, creating a directory for an associated language, and storing all screenshots for the associated language inside that directory.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for using natural language processing to assess display text element language and identify language defects in web applications according to embodiments of the present invention.

FIG. 2 is a flowchart illustrating a method, implemented using the system shown in FIG. 1, of using natural language processing to assess display text element language and identify language defects in web applications according to embodiments of the present invention.

FIG. 3 is a flowchart illustrating aspects of a method, implemented using the system shown in FIG. 1, of using natural language processing to assess display text element language and identify language defects in web applications according to embodiments of the present invention.

FIG. 4 is a schematic representation of aspects of a method, implemented using the system shown in FIG. 1, of using natural language processing to assess display text element language and identify language defects in web applications according to embodiments of the present invention.

FIG. 5 is a schematic representation of aspects of a method, implemented using the system shown in FIG. 1, of using natural language processing to assess display text element language and identify language defects in web applications according to embodiments of the present invention.

FIG. 6 is a schematic representation of aspects of a method, implemented using the system shown in FIG. 1, of using natural language processing to assess display text element language and identify language defects in web applications according to embodiments of the present invention.

FIG. 7 is a schematic representation of aspects of a defect report generated by the system shown in FIG. 1, of using natural language processing to assess display text element language and identify language defects in web applications according to embodiments of the present invention.

FIG. 8 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 9 depicts a cloud computing environment according to an embodiment of the present invention.

FIG. 10 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

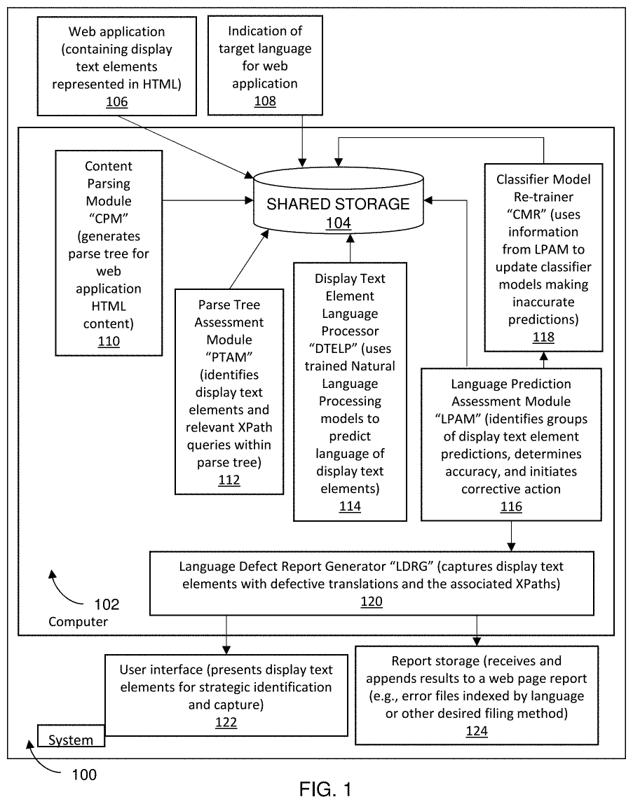

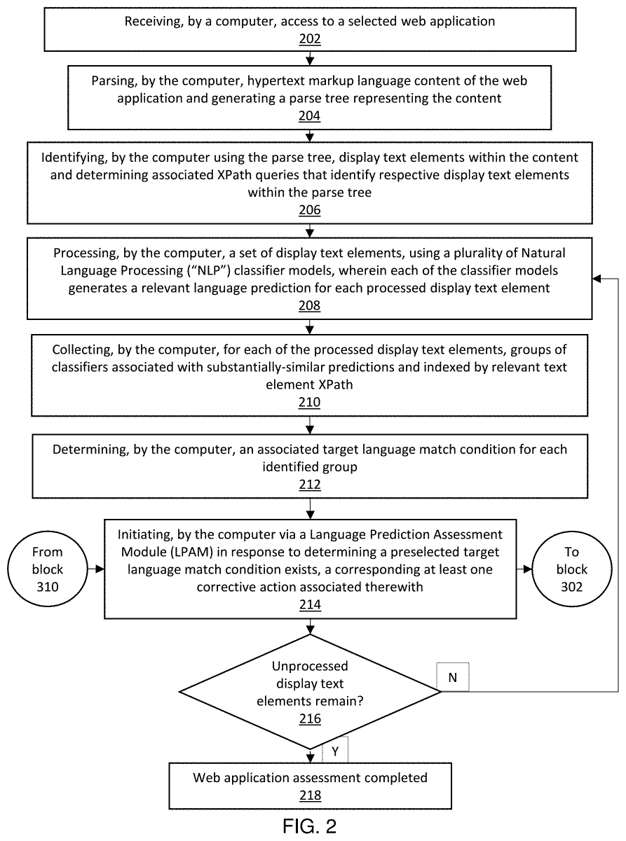

Now with combined reference to the Figures generally and with particular reference to FIG. 1 and FIG. 2, an overview of a method for using Natural Language Processing (NLP) to assess display text element language and identify language defects in web applications within a system 100 as carried out by a server computer 102 having optionally shared storage 104. The server computer 102 is in communication with a web application 106 that contains display text elements represented in Hypertext Markup Language (HTML). The server computer 102 is in communication with an indication of target language 108 for the web application 106. The server computer 102 includes a Content Parsing Module “CPM” 110 that generates a parse tree for web page HTML content. The server computer 102 includes Parse Tree Assessment Module “PTAM” 112 that identifies display text elements and relevant element selector queries within the parse tree. The server computer 102 includes Parse Tree Assessment Module “PTAM” 114 identifies display text elements and relevant element selector queries within the parse tree. The server computer 102 includes Language Prediction Assessment Module “LPAM” 116 that identifies groups of display text element predictions, determines accuracy, and initiates corrective actions. The server computer 102 includes Classifier Model Re-trainer “CMR” 118 that uses information from LPAM to update classifier models making inaccurate predictions. The server computer 102 includes Language Defect Report Generator “LDRG” 120 that captures display text elements with defective translations and the associated element selectors for the display text elements. The server computer 122 is in operative communication with a user interface 122 that presents display text elements for strategic identification (e.g. on-screen highlighting) and capture. The server computer 102 is in operative communication with report storage 124 that receives and appends results to a web page report (e.g., error files indexed by language or other desired filing method).

Now with specific reference to FIG. 2, and to other figures generally, a computer-implemented method for using natural language processing to assess display text element language and identify language defects in web applications using the system 100 will be discussed. The server computer 102 at block 202 receiving, by a computer, access to a selected web application 106. According to aspects of the invention, the web application 106 is associated with a target language 108, and in some settings, more than one language may be appropriate for the same application when used in multiple locales. According to aspects of the invention, assessments regarding display text element translation into various multiple target languages 108 may be conducted contemporaneously by tasking several classifier ensembles to validate translation into respective target languages in parallel.

The server computer 102 via Content Parsing Module “CPM” 110 at block 204, generates a parse tree for web application HTML content. In particular, the CPM 110 parses hypertext markup language content of the web application 106 and generates a parse tree representing the syntax and arrangement of content for the web page. According to aspects of the invention, the parse tree records the relationship among elements of the application, and each display text element is identified by a unique query that identifies the element within the page. It is noted that, while many kinds of indicia may be selected to represent display text, the use of element selectors is especially suited for use with aspects of the present invention. However, although an element selector query can be generated for each element in a provided web application, regardless of class names or element IDs provided within application metadata, other identification indicia selected by one skilled in this field may also suffice when used to uniquely identify the web application display text elements. For example, aspects of the invention may be successfully carried out by any indicia sufficient to uniquely identify display text elements within the parse tree. According to aspects of the invention, the parse tree links display text elements to corresponding selectors in the web application code (e.g. mapping to HTML content). Therefore once a display text element is identified, aspects of the invention indicate item position within application code, allowing subsequent element interaction (e.g., identification of defective language conditions, publication of error reports, and so forth).

The server computer 102, via Parse Tree Assessment Module “PTAM” 112 at block 206, identifies using the parse tree, display text elements within the content and determines respective element selector queries that identify the display text elements within the parse tree. According to aspects of the invention, display text elements are items shown to an end user during operation of the web application. It is noted that these elements might be shown on a user interface 122 upon initial content display and these elements might also be shown in response to user interaction with on-screen pull down menus or other hierarchical display text content.

The server computer 102, via Display Text Element Language Processor “DTELP” 114 at block 208, processing a set of display text elements, using a plurality of Natural Language Processing (“NLP”) classifier models, wherein each of the classifier models generates a relevant language prediction for each processed display text element. In particular, the DTELP 114 uses an ensemble of trained Natural Language Processing (NLP) models to independently predict a language associated with each of the display text elements. It is noted that different NLP classifiers have different strengths in terms of language classifications. For example, Naive Bayes classifiers are especially-suited for classifying short sequences within longer blocks of text, operating as though each word in a processed text block is independent from other words in the block. This is advantageous for finding improperly one or two mistranslated words within long sequences of text. A Recurrent Neural Network (RNN) is especially-suited to recognize long sequences of text and assumes a dependence between consecutive words in the text. This is effective for recognizing sequences of text that contain similar words in different languages.

According to aspects of the invention, the present ensemble learning approach allows for a majority vote (or some other threshold criteria) match condition among language predictions for a given display text element to identify a primary group of classifiers (e.g., a group representing a majority or other primary group threshold) correctly predicting a language substantially the same as an identified target language for the text element for a given locale. According to aspects of the invention, when this first match condition occurs, (e.g., a primary group exists and predicts a language substantially the same as the target language), aspects of the invention extract that text element and the element and target language as a training example to retrain any classifiers outside of the primary group, using the majority vote (e.g., presence of a primary group) to because we know what the correct classification is from our majority vote.

According to aspects of the invention, the present ensemble prediction model allows for a majority vote (or some other threshold criteria) match condition among language predictions for a given display text element to identify a primary group of classifiers (e.g., a group representing a majority or other primary group threshold) incorrectly predicting a language substantially different from an identified target language for the text element for a given locale. According to aspects of the invention, when this second match condition occurs, (e.g., a primary group exists and predicts a language substantially different from the target language), aspects of the invention flag the text as having an incorrect language condition (e.g., a defective translation). In an embodiment, when this second match conditions occurs, aspects of the invention extract the currently processed text element and the element and target language as a training example to retrain any classifiers outside of the primary group, using the majority vote (e.g., presence of a primary group) to because we know what the correct classification is from our majority vote.

According to aspects of the invention, the present ensemble prediction model accommodates situations where no primary group (e.g., no groups with a quantity exceeding the selected primary group threshold) exists to indicate a third match condition. In embodiment, when this third match condition occurs, it may not be clear whether the models are incorrectly trained or if the text element is incorrectly translated, and the server computer 102 will identify the text element as having a language defective and include the element as part of a group included in a defect report for further processing.

At least due to the tendencies described above, certain classifier models are more effective at classifying certain kinds of text input strings (e.g., to assess display text element language) than for others. For example, a Naive Bayes classifier model might, depending on the training data, predict that the language for the phrase, “omelet de fromage” is English text, because the word omelet is the same in English as French. Therefore the compounded probability for this sequence to be English or French will be very similar. On the other hand, Recurrent Neural Network RNN classifier will most certainly classify the same phrase, “omelet de fromage” French, since it will establish a dependence between “omelet” and “fromage” which exists in French but not in English.

It is noted that other, more subtle, differences may also exist among machine learning algorithms. These differences are due to the nature of the algorithms associated with the models and the empirical nature of training and model optimization (e.g., the same network with different hyperparameters will give different results). According to aspects of the invention, using different algorithms running in parallel provides an overall improvement in accuracy, by allowing for predictions based on a cross section of assessment strengths.

The server computer 102, via Language Prediction Assessment Module “LPAM” 116 at block 210, collects for each of the processed display text elements, groups of classifiers associated with substantially-similar predictions and indexed by relevant text element selector. In particular, the LPAM 116 uses each of several NLP classifiers (e.g., 2 or more classier models, with a quantity being selected by one skilled in this field) to determine a predicted language for a given display text element in a manner known to those in this field. According to aspects of the invention, the classifier models may be selected from among Naïve Bayes and Recurrent Neural Network (RNN) models, support vector machines, or other models identified by one skilled in this field. According to aspects of the invention, the classifiers selected preferably represent different processing strategies. The models may employ differing algorithms and models based on similar algorithms may be selected, as long as different hyperparameters or training data are used. Aspects of the invention consider the element selectors for all of the application content to recursively search for each display text element present in the web page 106, as associated with various target languages 108. According to aspects of the invention, LPAM identifies groups of display text element predictions (e.g., predictions that identify language #1, language #2, language #3, etc.).

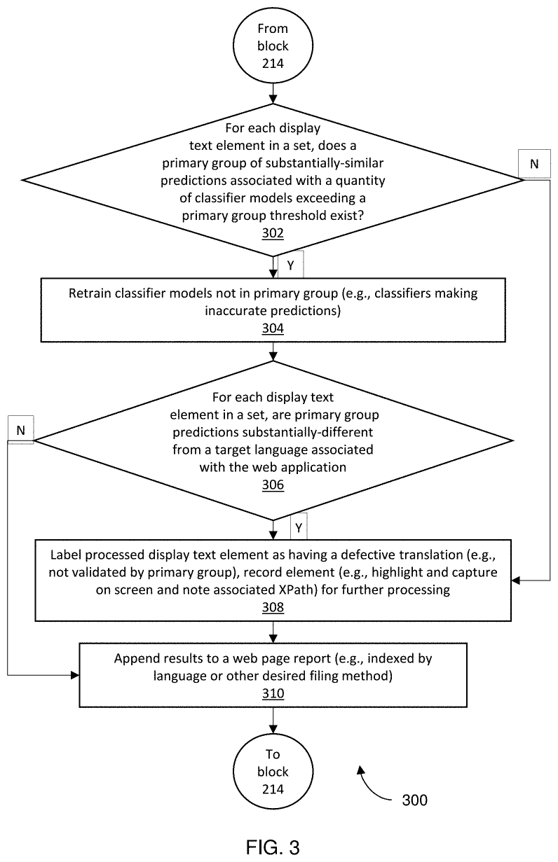

The server computer 102, via continued application of the LPAM 116 at block 212 determines, as will be explained further below with refence to FIG. 3 below, an associated target language match condition for each identified group of text display element language prediction results (e.g., conditions associated with a group of classifiers predicting the language for a text display element is language #1, etc.).

The server computer 102, via continued application of the LPAM 116 at block 214 initiates, in response to determining a preselected target language match condition exists, corresponding corrective actions associated with the match condition, with processing control flowing to block 302 through 310, as will be explained further below with refence to FIG. 3.

The server computer 102 iteratively determines at block 216 whether all display text elements (e.g., via recursive consideration of each display text element selector or other unique element identifier) have been processed, with flow returning to block 208 for further element processing if unprocessed elements (e.g., elements for which language validation has not yet occurred).

When all display text elements have been processed, flow continues to block 218 and the language assessment for a given locale is complete.

Now with particular reference to FIG. 3, aspects 300 of operation of the LPAM 116 will be discussed. At block 302, the server computer will determine for each display text element in a set (e.g. all elements associated with the web application 106 for a given locale), whether a primary group of substantially-similar predictions associated with a quantity of classifier models exceeding a primary group threshold exists. According to aspects of the invention, the primary group threshold quantity may be a majority amount, any plurality amount, a percentage selected by one skilled in this filed and so forth. If no primary group of classifiers exists, flow control is passed to block 308.

If the server computer 102 identifies a primary group of classifiers, flow continues to block 304, where the server computer 102, via Classifier Model Re-trainer “CMR” 118, retrains classifier models not in primary group (e.g., classifiers making inaccurate predictions) using the target language and the currently processed display text element content as a training data pair. Responsive to completion of retraining classifiers outside the primary group, flow continues to block 306.

The server computer determines, via LPAM 116 at block 306, whether for each display text element in a set, are primary group predictions substantially-different from a target language associated with the web application locale (e.g., whether a majority indicates the text element is incorrectly translated). If the primary group predictions are substantially the same as a target language, the element is deemed to be correctly translated (e.g., no language defect exists), no element correction is needed, and flow is directed to block 310. If the primary group predictions are substantially different from a target language, the element is deemed to be incorrectly translated (e.g., a language defect exists), corrective action is needed, and flow continues to block 308.

The server computer 102, via the LDRG 120 at block 308, labels the currently processed display text element as having a defective translation (e.g., not validated by primary group). In an embodiment, the LDRG 120 records the element (e.g., highlights the element within a user interface 122, initiates a screen capture showing the element and note the associated element selector) for further processing. According to aspects of the invention, the screen capture may occur when all display text elements having a language defect are highlighted.

The server computer 102, via LDRG 120 at block 310, appends defect element information to a web page report (e.g., indexed by language or other desired filing method) for storage or further processing (e.g., passing along for element retranslation, etc.) and flow returns to block.

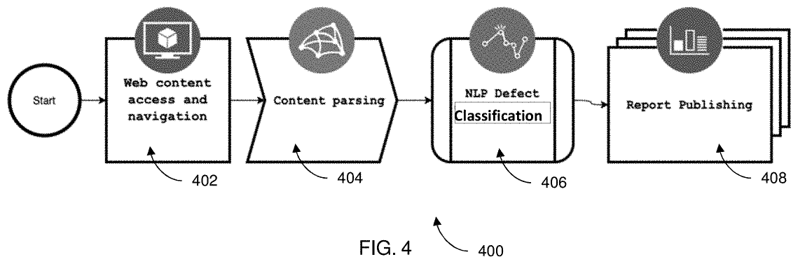

Now with particular reference to FIG. 4, a schematic representation of an overview 400 of aspects of a method, implemented using the system shown in FIG. 1, of using natural language processing to assess display text element language and identify language defects in web applications according to embodiments of the present invention will be discussed. In block 402, the server computer 102 receives access to content and associated navigation language structure for a web application 106. At block 404, the server conductor parses the web application content. At block 406, the server compute conducts NLP classification of the parsed content to determine whether display text elements contain text written in a target language. At block 408, the server computer 102 generates and publishes a report indicating language defects (e.g., elements not confirmed to be written in a target language).

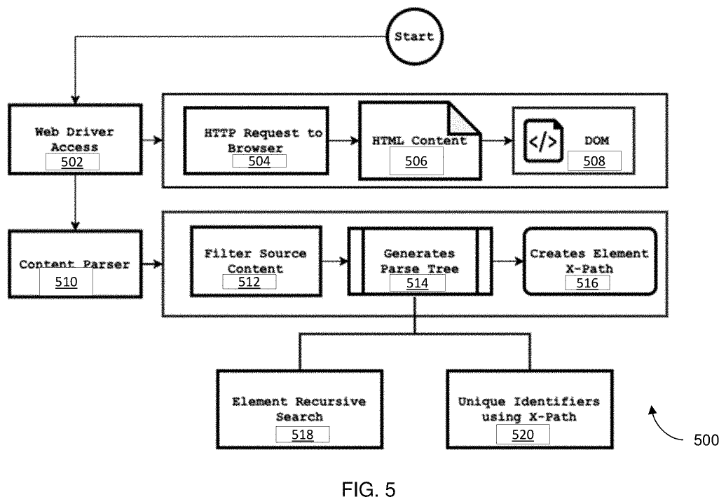

Now with particular reference to FIG. 5, a schematic representation of an overview 500 of content access and parsing aspects of a method, implemented using the system shown in FIG. 1, of using natural language processing to assess display text element language and identify language defects in web applications according to embodiments of the present invention will be discussed. The server computer 102 using a web application testing utility with a testing routine (e.g., a web driver) at block 502 sends an HTTP request to a web browser at block 504, and the browser grants access to the HTML source content of the web application at block 506. At block 508 the browser generates a structured version of the source content document object model (e.g., a content DOM). The server computer 102 passes the DOM to the content parser at block 510, and the parser filters the DOM content, removing unnecessary information such as metadata, script tags, and so forth, leaving display text elements for processing. The server computer 102, at block 514, generates a parse tree for the parsed elements and extracts a unique element selector associated with each node in the tree. According to aspects of the invention, the tree maintains the structure of the DOM, and the server computer 102 generates element selector queries for each element in the DOM. According to aspects of the invention, the parse tree promotes efficient and through language error detection. Aspects of the invention use the parse tree to recursively search for each element in the DOM. Aspects of the invention, use the element selector to access all application elements and to performing operations on the given element node. In an embodiment, the parse tree promotes thorough application element access and efficient highlighting of text elements that would otherwise be hidden in a user interface display unless triggered (e.g., drop down menu or other interactive display items having text). According to aspects of the invention, the parser provides embeddings (e.g., classifier model input) for identified display text elements to the classifier models for downstream language assessment. The server computer 102 conducts, at block 518, recursive element search to ensure unique element selector identifiers are generated at block 520 for each element.

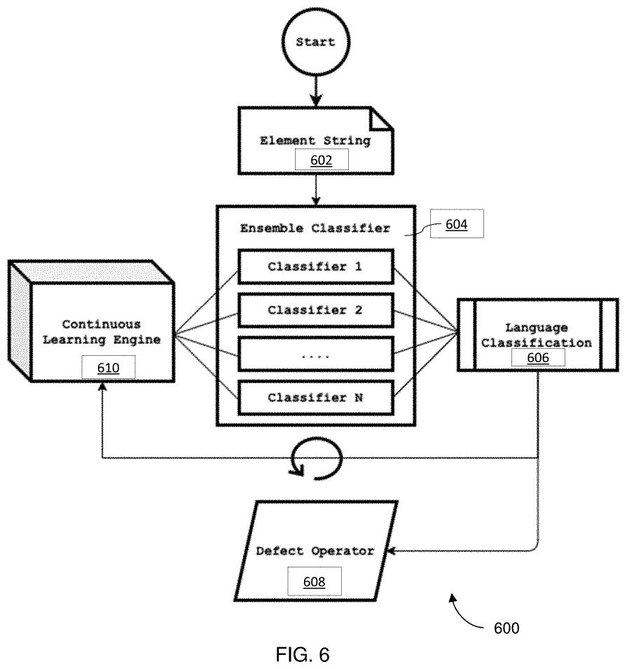

Now with particular reference to FIG. 6, a schematic representation of an overview 600 of defect determination aspects of a method, implemented using the system shown in FIG. 1, of using natural language processing to assess display text element language and identify language defects in web applications according to embodiments of the present invention will be discussed. The server computer 102 at block 602 receives an input string (e.g. from the parser) for language assessment. The server computer 102 processes, at block 604, the input string in a classifier ensemble able to operate multiple language classifiers in parallel. These classifiers use various NLP methods to identify language for the input string (e.g., text associated with display text elements). It is noted the using multiple classifiers increases prediction confidence and accuracy, while also expanding the scope of errors captured by the server computer 102. For example, a Naive Bayes classifier might detect defects that a support vector machine won't detect and vice versa. In an embodiment, the classifiers perform a majority vote (e.g., if a primary group having a quantity that meets a primary group threshold) agree on a specific answer, that classification is deemed correct. The server computer 102, at block 608, via a defect operator (e.g., the LPAM 116) determines if the identified language should be flagged as a defect. The server computer 102 initiates a feedback loop that updates, via the CMR 118, models generating incorrect language predictions through a continuous learning engine at block 610. According to aspects of the invention, learning engine is a continuous dynamic optimizer for the ensemble of machine learning models. When a language classification occurs on an input string, if any of the models misclassified that language, the learning engine will retrain the model using the input string (e.g., text element) and the classified language (e.g., target language) as a training example. In this way, data generated during ongoing use continuously improves classifier prediction performance.

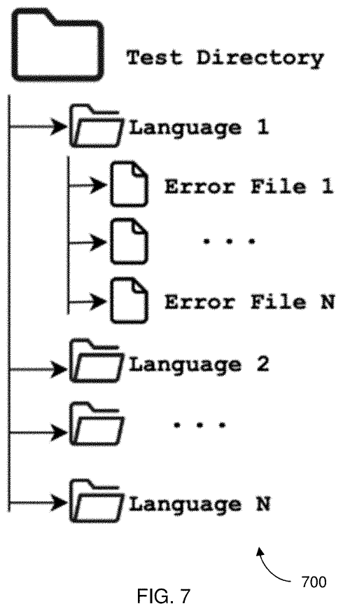

Now with particular reference to FIG. 7, a schematic representation of an overview 700 of defect determination and report generation aspects of a method, implemented using the system shown in FIG. 1, of using natural language processing to assess display text element language and identify language defects in web applications according to embodiments of the present invention will be discussed. Aspects of the invention highlight elements with detected language defect in the UI 122 using associated element selectors extracted from the parse tree. Aspects of the invention capture screenshots that highlight elements identified as having language defects. Aspects of the invention format a report directory (e.g., following the arrangement shown schematically in FIG. 7) with all the errors for each language (e.g., per locale). According to aspects of the invention, stored defect reports (e.g., reports showing translation errors) serve multiple purposes. In an embodiment, the reports provide information to translation teams that indicate all the defects that require change. In an embodiment, the reports provide locations and source code information for all identified language defects, so developers (or other downstream processors) can easily externalize the translations.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

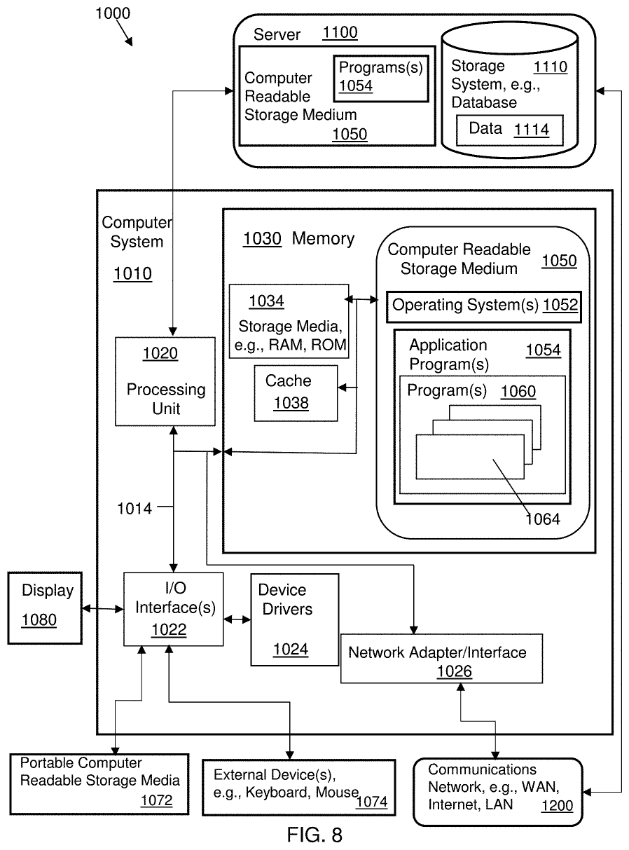

Referring to FIG. 8, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

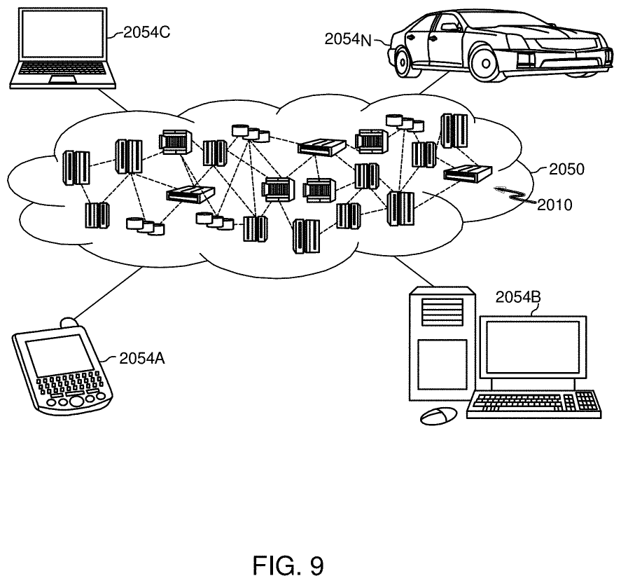

Referring now to FIG. 9, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

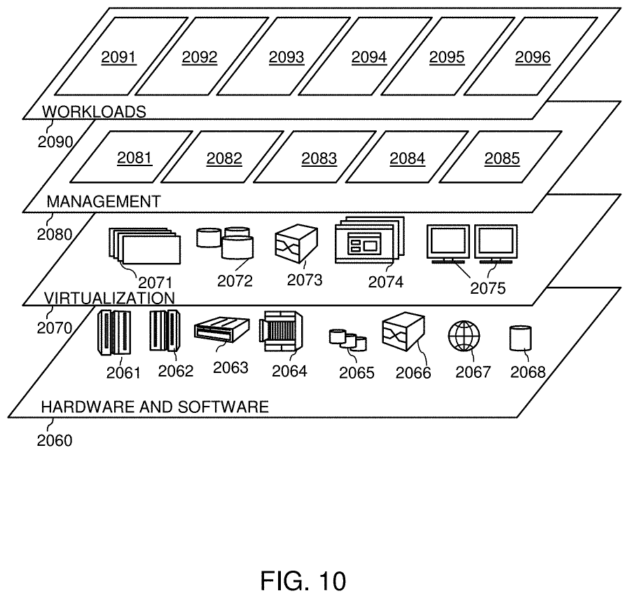

Referring now to FIG. 10, a set of functional abstraction layers provided by cloud computing environment 2050 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and using natural language processing to assess display text element language and identify language defects in web applications.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method for assessing language attributes of web application display text elements, comprising:
parsing, by a computer, hypertext markup language content of a web application and generating a parse tree representing the content;
linking display text elements to corresponding selectors in web application code of the web application using the parse tree;
identifying, by the computer using the parse tree, display text elements within the content and determining associated element selector queries that identify respective display text elements within the parse tree;
in response to the identifying of the display text elements, indicating item positions within the web application code for allowing subsequent element interaction;
processing, by the computer, a set of display text elements, using an ensemble learning method implementing a plurality of Natural Language Processing (“NLP”) classifier models, wherein each of the classifier models generates a relevant language prediction for each processed display text element;
collecting by the computer, for each of the processed display text elements, groups of classifiers associated with substantially-similar predictions and indexed by relevant text element selector;
determining by the computer an associated target language match condition for each identified group;
initiating, by the computer in response to determining a preselected target language match condition exists;
predicting for the identifying of the display text elements, a primary group of classifiers representing a threshold for the primary group;
determining, the predicting incorrectly predicted a language different from an identified target language for the text elements for a locale; and
initiating, by the computer in response to the determining of the predicting incorrectly predicting the language as different from the identified target language, corresponding at least one corrective action associated with the incorrectly predicting.

2. The method of claim 1, further including identifying, by the computer, a primary group of substantially-similar predictions associated with a quantity of classifier models exceeding a primary group threshold of the classifier models;
wherein the preselected match condition is that the associated predictions of the primary group are substantially-different from a target language prediction associated with the web application and available to the computer; and
wherein the at least one responsive action includes generating a text element language defect report identifying the element selector associated with the at least one processed display text element.

3. The method of claim 2, further including training, by the computer, any of the plurality of classifier models not included in the primary group, using training data pair including the target language and associated processed display text element.

4. The method of claim 1, further including identifying, by the computer, a primary group of substantially-similar predictions associated with a quantity of classifier models exceeding primary group threshold of the classifier models;
wherein the preselected match condition is that the associated predictions of the primary group are substantially-similar to a target language associated with the web application and available to the computer; and
wherein the at least one responsive action includes training any of the plurality of classifier models not included in the primary group, using training data pair including the target language and associated processed display text element.

5. The method of claim 1, further including determining, by the computer, that each group of substantially-similar predictions is associated with a quantity of classifier models lower than a primary group threshold of the classifier models; and
wherein the at least one responsive action includes generating a text element language defect report identifying the element selector associated with the at least one processed display text element.

6. The method of claim 1, wherein the plurality is at least one of classifiers is selected from the group consisting of Naïve Bayes classifiers, Recurrent Neural Network (RNN) classifiers, and support vector machine classifiers.

7. The method of claim 1, wherein the set display text elements is generated by iterating through the element selectors associated with each respective display text elements within the parse tree.

8. A system for assessing language attributes of web application display text elements, which comprises:
a computer system comprising; a computer processor, a computer-readable storage medium, and program instructions stored on the computer-readable storage medium being executable by the processor, to cause the computer system to perform the following functions to;
receive access to a selected web application;
parse hypertext markup language content of the web application and generating a parse tree representing the content;
link display text elements to corresponding selectors in web application code of the web application using the parse tree;
identify using the parse tree, display text elements within the content and determining associated element selector queries that identify respective display text elements within the parse tree;
in response to the identifying display text elements, indicate item positions within the web application code for allowing subsequent element interaction;
process a set of display text elements, using an ensemble learning method implementing a plurality of Natural Language Processing (“NLP”) classifier models, wherein each of the classifier models generates a relevant language prediction for each processed display text element;
collect for each of the processed display text elements, groups of classifiers associated with substantially-similar predictions and indexed by relevant text element selector;
determine an associated target language match condition for each identified group;
initiate in response to determining a preselected target language match condition exists;
predict for the identification of the display text elements, a primary group of classifiers representing a threshold for the primary group;
determine, the prediction incorrectly predicted a language different from an identified target language for the text elements for a locale; and
initiate, by the computer in response to the determining of the predicting incorrectly predicting the language as different from the identified target language, corresponding at least one corrective action associated with the incorrect prediction.

9. The system of claim 8, further including instruction causing the computer to identify a primary group of substantially-similar predictions associated with a quantity of classifier models exceeding a primary group threshold of the classifier models;
wherein the preselected match condition is that the associated predictions of the primary group are substantially-different from a target language prediction associated with the web application and available to the computer; and
wherein the at least one responsive action includes generating a text element language defect report identifying the element selector associated with the at least one processed display text element.

10. The system of claim 9, further including instructions causing the computer to train any of the plurality of classifier models not included in the primary group, using training data pair including the target language and associated processed display text element.

11. The system of claim 8, further including identifying a primary group of substantially-similar predictions associated with a quantity of classifier models exceeding primary group threshold of the classifier models;
wherein the preselected match condition is that the associated predictions of the primary group are substantially-similar to a target language associated with the web application and available to the computer; and
wherein the at least one responsive action includes training any of the plurality of classifier models not included in the primary group, using training data pair including the target language and associated processed display text element.

12. The system of claim 8, further including determining that each group of substantially-similar predictions is associated with a quantity of classifier models lower than a primary group threshold of the classifier models; and
wherein the at least one responsive action includes generating a text element language defect report identifying the element selector associated with the at least one processed display text element.

13. The system of claim 8, wherein the plurality is at least one of classifiers is selected from the group consisting of Naïve Bayes classifiers, Recurrent Neural Network (RNN) classifiers, and support vector machine classifiers.

14. The system of claim 8, wherein the set display text elements is generated by iterating through the element selectors associated with each respective display text elements within the parse tree.

15. A computer program product for assessing language attributes of web application display text elements, the computer program product comprising a computer readable storage medium having program instructions embodied therewith, the program instructions executable by a computer to cause the computer to perform functions comprising functions to:
receive, using a computer, access to a selected web application;
parse, using the computer, hypertext markup language content of the web application and generating a parse tree representing the content;
link display text elements to corresponding selectors in web application code of the web application using the parse tree;
identify, using the computer, using the parse tree, display text elements within the content and determining associated element selector queries that identify respective display text elements within the parse tree;
in response to the identifying display text elements, indicate item positions within the web application code for allowing subsequent element interaction;
process, using the computer, a set of display text elements, using an ensemble learning method implementing a plurality of Natural Language Processing (“NLP”) classifier models, wherein each of the classifier models generates a relevant language prediction for each processed display text element;
collect, using the computer, for each of the processed display text elements, groups of classifiers associated with substantially-similar predictions and indexed by relevant text element selector;
determine, using the computer, an associated target language match condition for each identified group;
initiate, using the computer, in response to determining a preselected target language match condition exists;
predict for the identification of the display text elements, a primary group of classifiers representing a threshold for the primary group;
determine, the prediction incorrectly predicted a language different from an identified target language for the text elements for a locale; and
initiate, by the computer in response to the determining of the predicting incorrectly predicting the language as different from the identified target language, corresponding at least one corrective action associated with the incorrect prediction.

16. The computer program product of claim 15, further including instruction causing the computer to identify a primary group of substantially-similar predictions associated with a quantity of classifier models exceeding a primary group threshold of the classifier models;
wherein the preselected match condition is that the associated predictions of the primary group are substantially-different from a target language prediction associated with the web application and available to the computer; and
wherein the at least one responsive action includes generating a text element language defect report identifying the element selector associated with the at least one processed display text element.

17. The computer program product of claim 16, further including instructions causing the computer to train any of the plurality of classifier models not included in the primary group, using training data pair including the target language and associated processed display text element.

18. The computer program product of claim 15, further including identifying a primary group of substantially-similar predictions associated with a quantity of classifier models exceeding primary group threshold of the classifier models;
wherein the preselected match condition is that the associated predictions of the primary group are substantially-similar to a target language associated with the web application and available to the computer; and
wherein the at least one responsive action includes training any of the plurality of classifier models not included in the primary group, using training data pair including the target language and associated processed display text element.

19. The computer program product of claim 15, further including determining that each group of substantially-similar predictions is associated with a quantity of classifier models lower than a primary group threshold of the classifier models; and
wherein the at least one responsive action includes generating a text element language defect report identifying the element selector associated with the at least one processed display text element.

20. The computer program product of claim 15, wherein the set display text elements is generated by iterating through the element selectors associated with each respective display text elements within the parse tree.
